(19) United States
(12) Patent Application Publication
(10) Pub. No.: US 2007/0062973 A1
(43) Pub. Date: Mar. 22, 2007

(54) Water bottle with dimples

(76) Inventor: Marcin Sochacki, Austin, TX (US)

Correspondence Address: Matthew J. Booth & Associates, PLLC, P O BOX 50010, AUSTIN, TX, 78763-0010, US

(21) Appl. No.: 11/353,295

(22) Filed: Feb. 13, 2006

Related U.S. Application Data
(60) Provisional application No. 60/593,780, filed on Feb. 13, 2005.

(51) Int. Cl. A45F 5/00; B67D 5/64; B62J 11/00; E01C 19/20

(52) U.S. Cl. 222/175; 224/414; 222/610; 224/148.4

(57) ABSTRACT

The present invention is a water bottle or liquid container (10) that reduces aerodynamic drag. The liquid container comprises a surface with a plurality of dimples. The dimples comprises a number of different sized and shaped dimples.

### CROSS REFERENCE TO RELATED APPLICATIONS

This application claims the benefits of the earlier filed U.S. Provisional Application Ser. No. 60/593,780, filed 13 Feb. 2005, which is incorporated by reference for all purposes into this specification.

### FIELD OF THE INVENTION

The present invention relates to cycling accessories. More specifically, the present invention relates to a water bottle or liquid container for use in use in cycling.

### DESCRIPTION OF THE RELATED ART

Water bottles or liquid containers for cycling enthusiasts and professionals come in a variety of shapes and sizes. The current products, however, all share a common problem, i.e., the surface of the containers have smooth surfaces. A smooth surface creates a certain amount of turbulence around the container, which in turn creates an amount of drag around the container that as a result will help cause the cyclist to slow down.

The present invention is a novel water bottle or liquid container that reduces the drag caused by the smooth surface of the container.

### SUMMARY OF THE INVENTION

The present invention is a water bottle or liquid container (10) that reduces aerodynamic drag. The liquid container comprises a surface with a plurality of dimples. The dimples comprises a number of different sized and shaped dimples.

### DESCRIPTION OF THE DRAWINGS

To further aid in understanding the invention, the attached drawings help illustrate specific features of the invention and the following is a brief description of the attached drawings:

FIG. 1 shows one embodiment of the present invention.

FIGS. 2A, B, C, D, and E illustrates different embodiments of the dimples of the present invention.

FIGS. 3A and B the differences in turbulence and drag between prior art containers and the present invention.

FIG. 4 illustrates the top of the present invention that comprises a number of different sized dimples.

FIG. 5 illustrates the middle neck of the present invention that comprises a number of different sized dimples.

FIG. 6 illustrates the bottom of the present invention that comprises a number of different sized dimples.

FIG. 7 illustrates the main body of the present invention that comprises a number of different sized dimples.

FIG. 8 is an enlargement of the main body that comprises a number of same sized dimples.

FIG. 9 is another enlargement of the main body that comprises a number of same sized dimples.

FIG. 10 is enlargement of the middle neck of the present invention that comprises a number of different sized dimples.

FIG. 11 is enlargement of the bottom of the present invention that comprises a number of different sized dimples.

FIG. 12 is enlargement of the top of the present invention that comprises a number of different sized dimples.

FIGS. 13A and B illustrates the spacing and sizing of dimples that comply with the NACA0040 standard.

FIGS. 14A, B, C, and D illustrate another embodiment of the present invention.

FIGS. 15A and B illustrate another embodiment of the present invention.

### DETAILED DESCRIPTION OF THE INVENTION

The present invention is a method and apparatus for a water bottle or liquid container with dimples that reduces aerodynamic drag around container. This disclosure describes numerous specific details that include specific structures and aerodynamic forces. For example, the present invention describes liquid containers used for water or other types of hydration. One skilled in the art will appreciate that one may practice the present invention without these specific details.

The present invention is an Aerodynamic Water Bottle modeled after an aircraft wing with the addition of strategically placed hexagonal dimples on the bottle surface. One embodiment of the present invention comprises a main cross section shape that is modeled after the airfoil profile designation NACA0040. The dimples are hexagonal in shape and are placed over the bottle where turbulent air flow does or may exist. The water bottle is design to be used in bicycles to reduce drag over conventional water bottles.

The present invention is also a conventional water bottle that is shaped and modeled per the attached drawings. The bottle contains traditional shape but contain the addition of hexagonal dimples on the bottle surface. Dimples are hexagonal in shape and are placed over the bottle where turbulent air flow does or may exist. The water bottle is design to be used in bicycles to reduce drag over conventional water bottles.

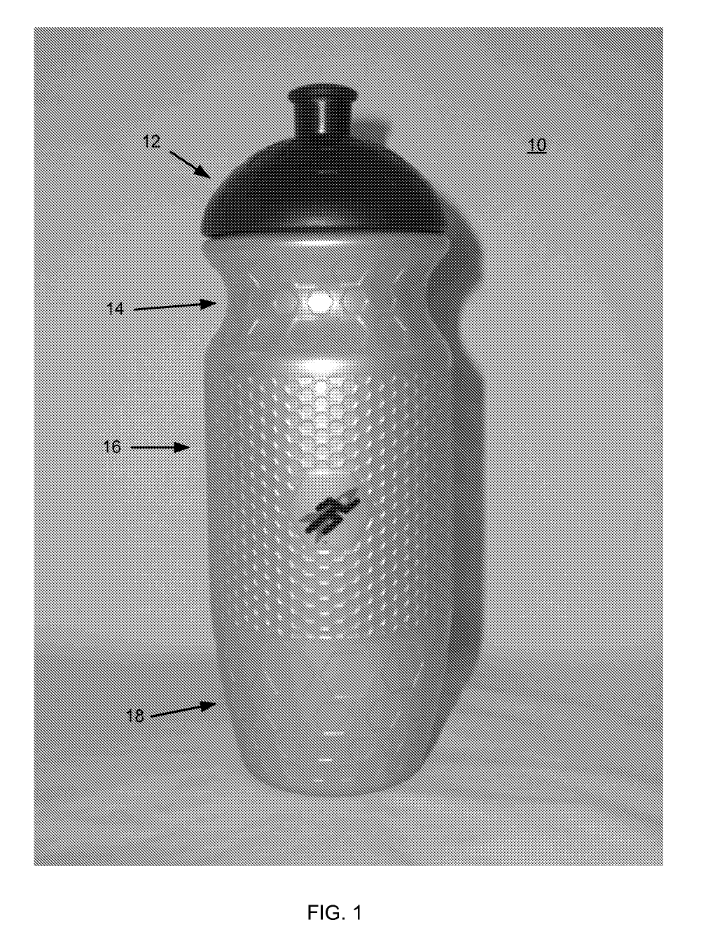

The present invention comprises placing various sizes and or shapes of dimples onto a cycling water bottle in order to reduce drag. FIGS. 1 though 15 reference various dimple placement combinations and shapes. The container may be made out of plastic or some type of composite material. The dimples on the container made be formed during the injection molding process of the container or by other molding processes. One skilled in the art will appreciate the number of materials and processes that may be used to create liquid containers for cycling. Additionally, one skilled in the art will appreciate that there are a number of processes available for creating custom shapes and or surface patterns during the process of injection molding.

The novelty in the water bottle or liquid container of the present invention is its unique aerodynamic design that is modeled after the golf ball to minimize drag while cycling. The majority of drag associated with water bottles results from the separation of airflow causing what's known as pressure drag. Air flowing past a traditional smooth exterior water bottle separates quickly resulting in a high pressure drag.

However, with the dimpled water bottle of the present invention, airflow separation is delayed. This results in a smaller airflow separation region when compared to traditional water bottle designs. The dimples actually add more kinetic energy to the airflow forcing it to remain attached longer that ultimately reduces pressure drag.

FIG. 1 shows one embodiment of the present invention. The present invention 10 comprises a top 12, and middle neck 14, a main body 16, and a bottom 18.

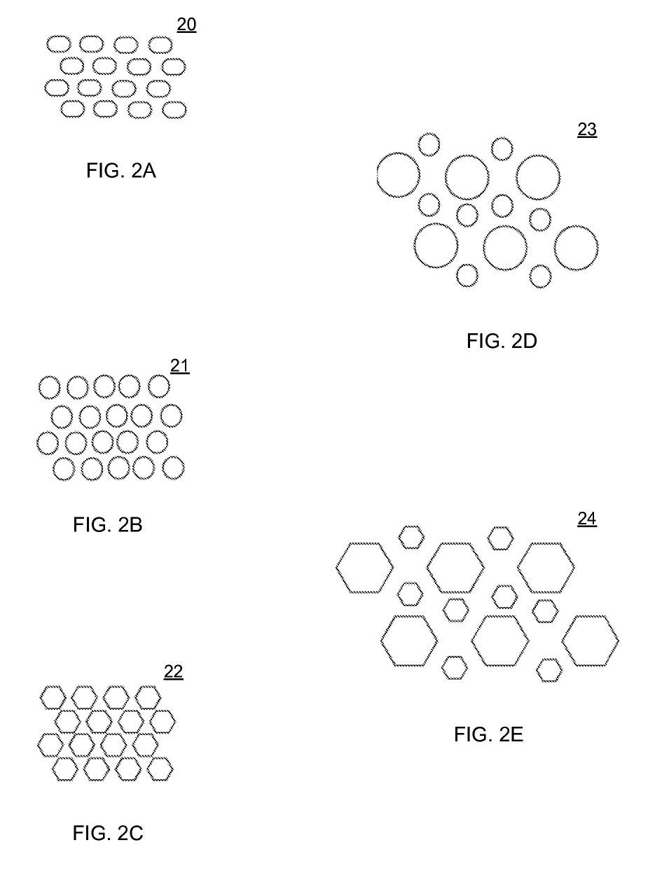

FIGS. 2A, B, C, D, and E illustrates different embodiments of the dimples of the present invention. FIG. 2A illustrates a dimple pattern where the dimples are the same size and are oval shaped. FIG. 2B illustrates a dimple pattern where the dimples are the same size and are circular shaped. FIG. 2C illustrates a dimple pattern where the dimples are the same size and are hexagonal shaped. FIG. 2D illustrates a dimple pattern where the dimples are the different sizes and are circular shaped. FIG. 2E illustrates a dimple pattern where the dimples are the different sizes and are a hexagonal shaped.

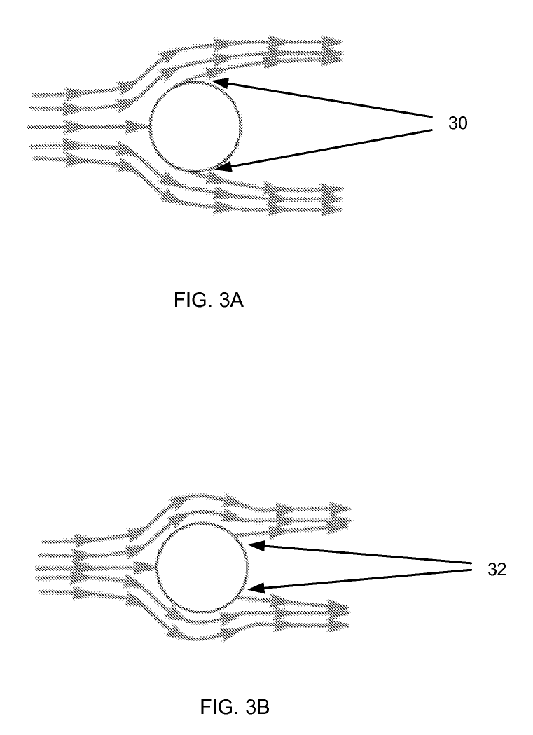

FIGS. 3A and B the differences in turbulence and drag between prior art containers and the present invention. FIG. 3A illustrates the turbulence and drag of prior art containers with a smooth surface. FIG. 3B illustrates the turbulence and drag of the present invention with dimpled surfaces.

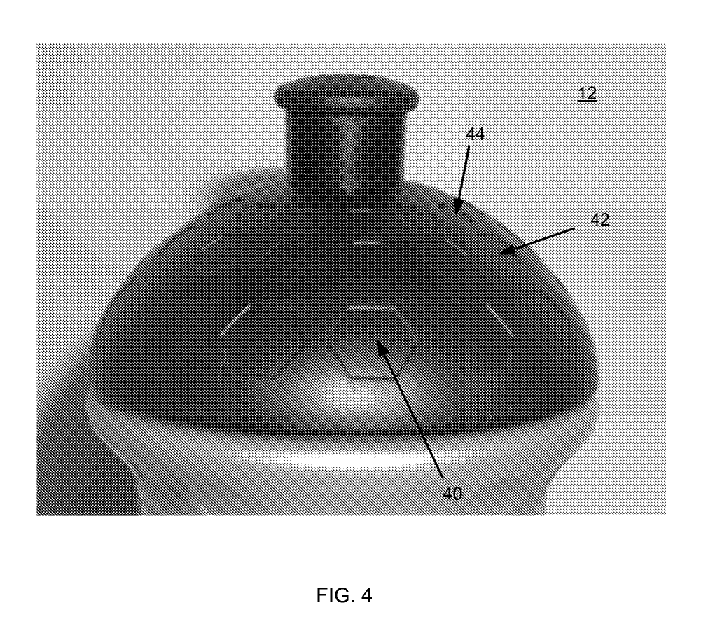

FIG. 4 illustrates the top 12 of the present invention that comprises a number of different sized dimples. The dimples are 40, 42, and 44.

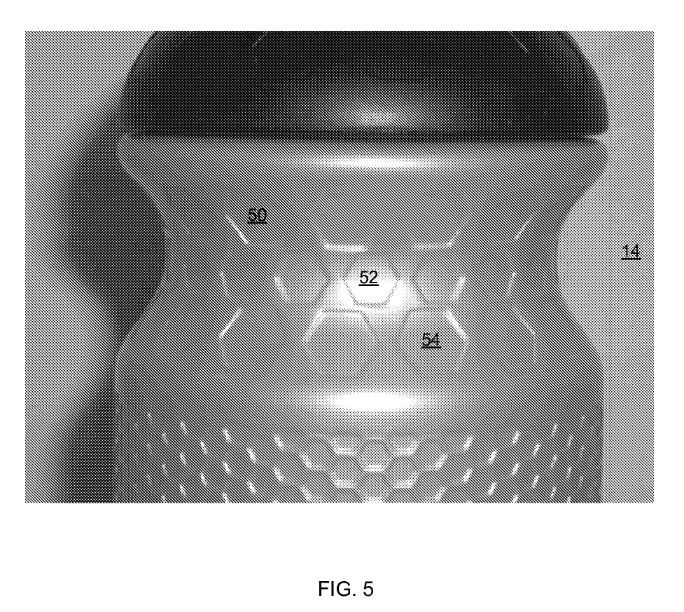

FIG. 5 illustrates the middle neck 14 of the present invention that comprises a number of different sized dimples. The dimples are 50, 52, and 54.

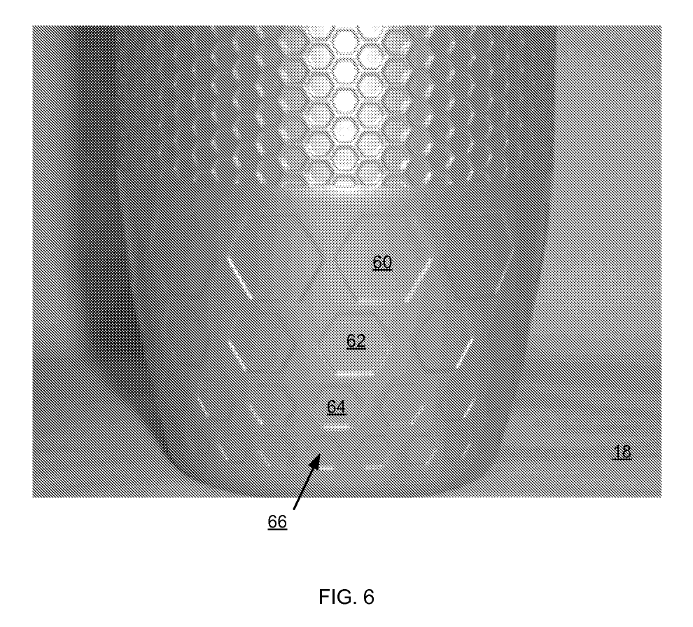

FIG. 6 illustrates the bottom 18 of the present invention that comprises a number of different sized dimples. The dimples are 60, 62, 64, and 66.

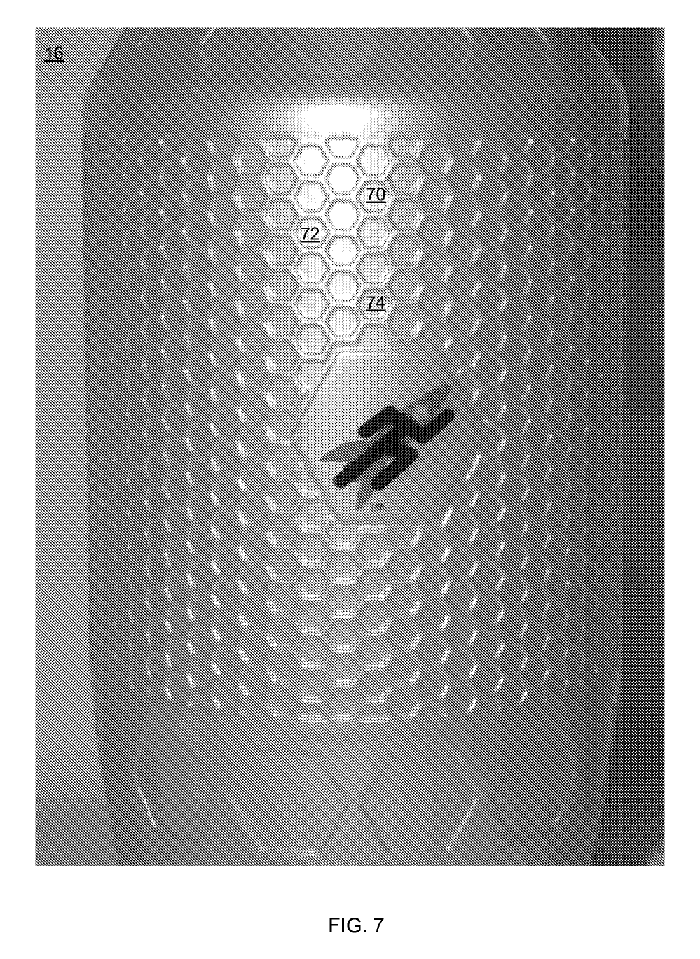

FIG. 7 illustrates the main body 16 of the present invention that comprises a number of different sized dimples. The dimples are 70, 72, and 74.

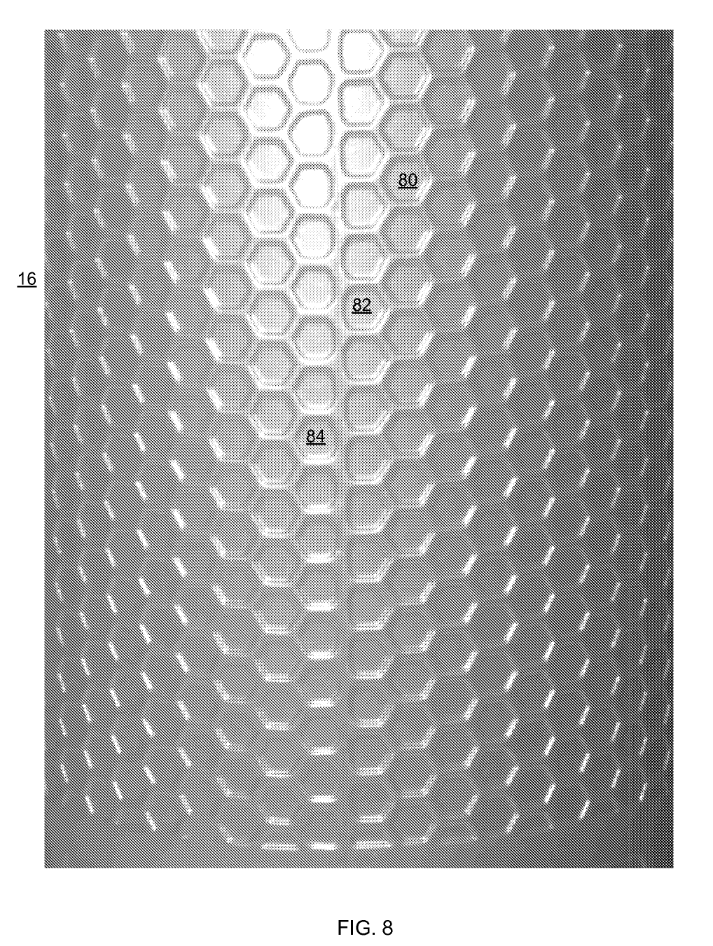

FIG. 8 is an enlargement of the main body 16 that comprises a number of same sized dimples. The dimples are 80, 82, and 84.

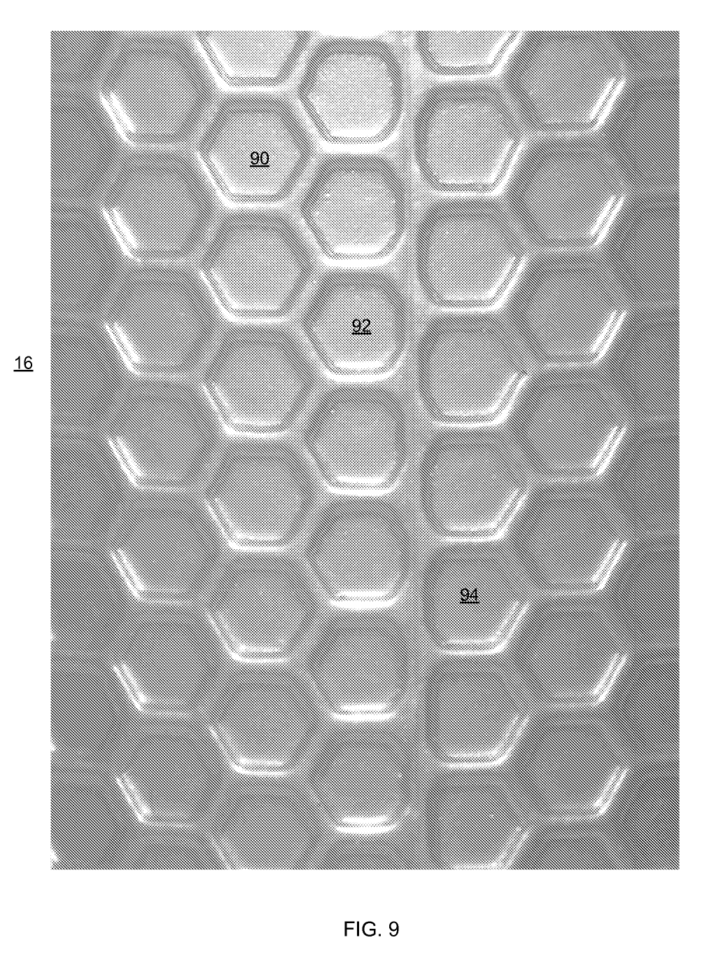

FIG. 9 is another enlargement of the main body 16 that comprises a number of same sized dimples. The dimples are 90, 92, and 94.

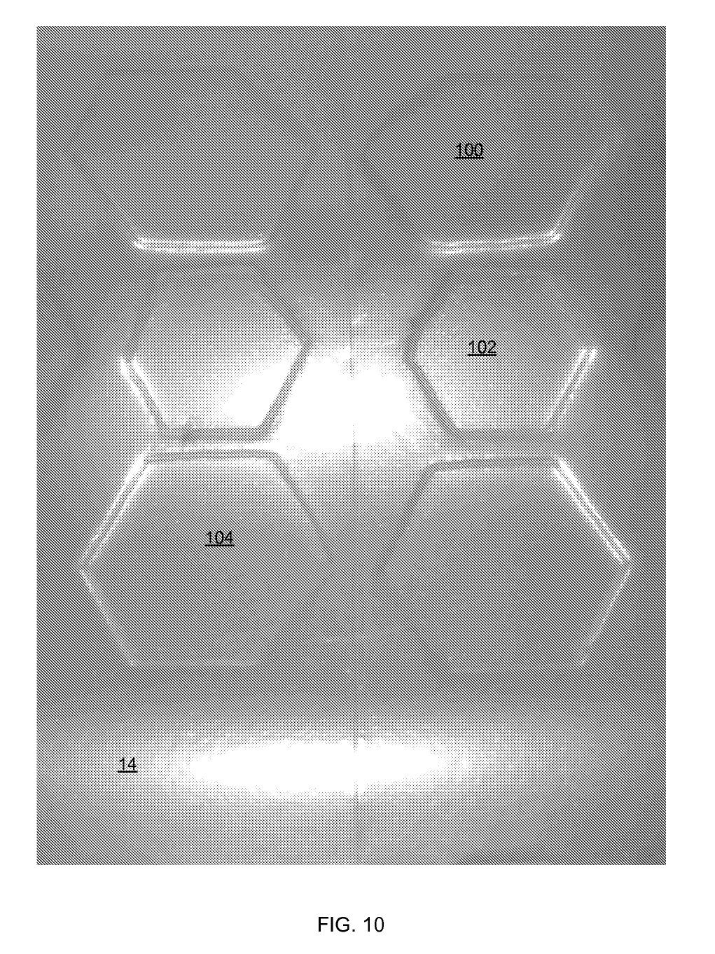

FIG. 10 is enlargement of the middle neck 14 of the present invention that comprises a number of different sized dimples. The dimples are 100, 102, and 104.

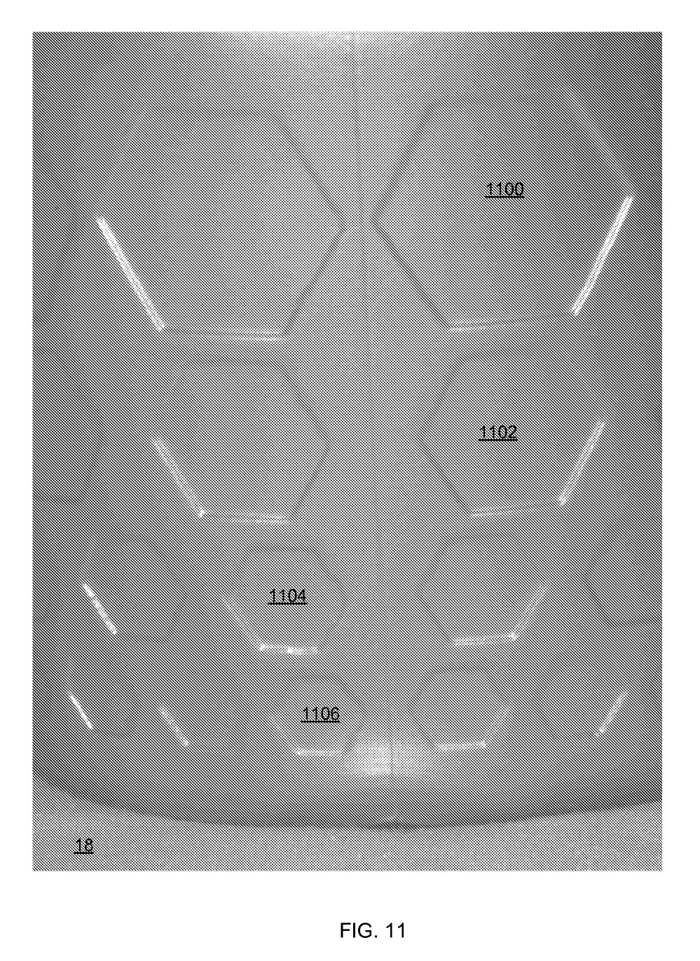

FIG. 11 is enlargement of the bottom 18 of the present invention that comprises a number of different sized dimples. The dimples are 1100, 1102, 1104, and 1106.

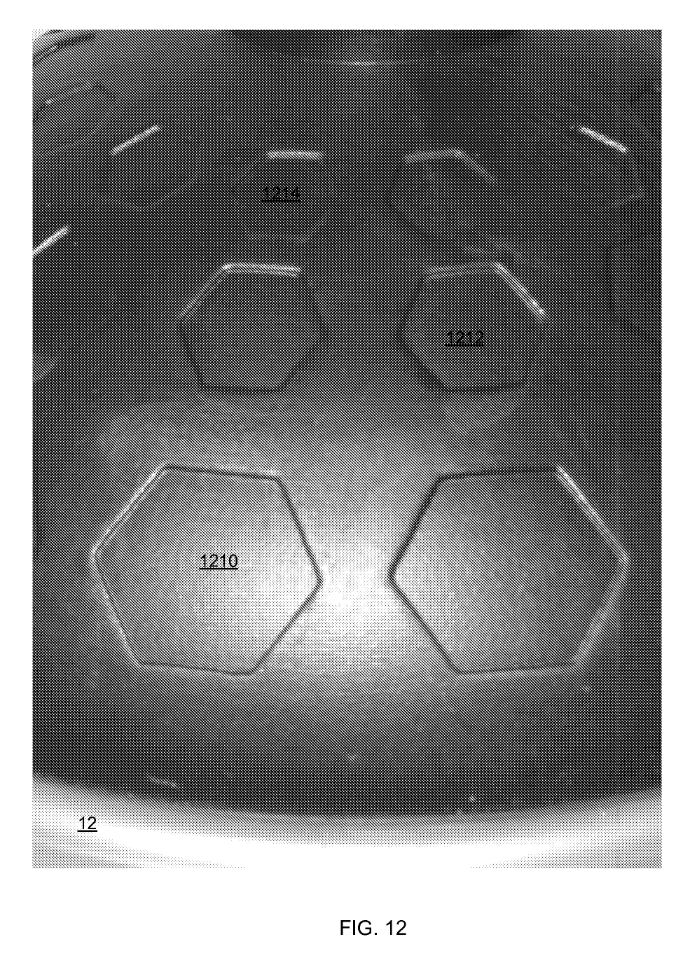

FIG. 12 is enlargement of the top 12 of the present invention that comprises a number of different sized dimples. The dimple is 1210 and 1212.

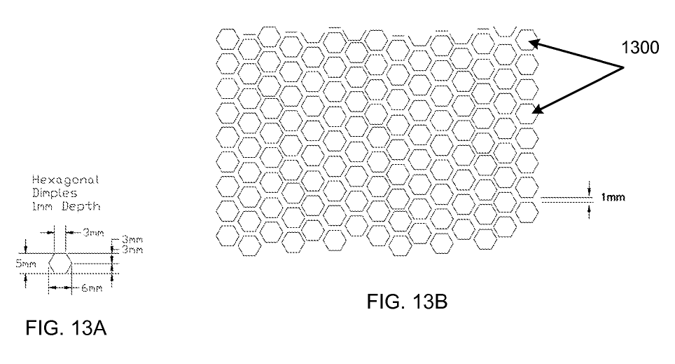

FIGS. 13A and B illustrates the spacing and sizing of dimples that comply with the NACA0040 standard. FIG. 13A illustrates the sizing requirements for the standard. FIG. 13B illustrates the spacing requirements for the standard.

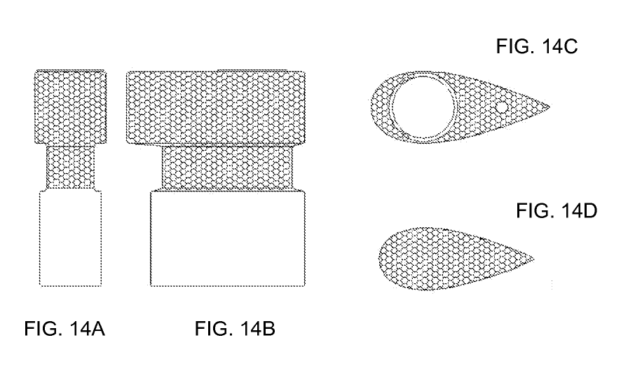

FIGS. 14A, B, C. and D illustrate another embodiment of the present invention. FIG. 14A is a back view of another embodiment of the present invention. FIG. 14B is a side view of another embodiment of the present invention. FIG. 14C and FIG. 14D are top views of another embodiment of the present invention.

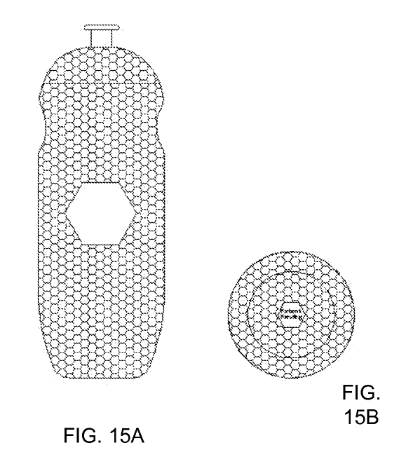

FIGS. 15A and B illustrate another embodiment of the present invention. FIG. 15A is a side view of another embodiment of the present invention. FIG. 15B is a top view of another embodiment of the present invention.

To summarize, the present invention is a water bottle or liquid container (10) that reduces aerodynamic drag. The liquid container comprises a surface with a plurality of dimples. The dimples comprises a number of different sized and shaped dimples.

Other embodiments of the invention will be apparent to those skilled in the art after considering this specification or practicing the disclosed invention. The specification and examples above are exemplary only, with the true scope of the invention being indicated by the following claims.

What is claimed is:

1. A liquid container that reduces aerodynamic drag, comprising:
a liquid container with a surface; and
wherein said surface comprises a plurality of dimples or patterns molded into said container.

2. A method to make a liquid container that reduces aerodynamic drag, comprising:
molding a liquid container with a surface; and
wherein said surface comprises a plurality of dimples or patterns molded into said container.

3. A method to use a liquid container that reduces aerodynamic drag, comprising:
storing a hydrating fluid in a liquid container with a surface; and
wherein said surface comprises a plurality of dimples or patterns molded into said container.

4. The claim of claim 1 wherein said dimples comprise one or more different sized and shaped dimples.

5. The method of claim 2 wherein said dimples comprise one or more different sized and shaped dimples.

6. The method of claim 3 wherein said dimples comprise one or more different sized and shaped dimples.
